(19) United States
(12) Patent Application Publication
(10) Pub. No.: US 2006/0118987 A1
(43) Pub. Date: Jun. 8, 2006

(54) Method of patterning molded article surface

(75) Inventors: Nobuyoshi Yukihira, Fukuoka (JP); Tomohiro Taniguchi, Fukuoka (JP)

Correspondence Address: JORDAN AND HAMBURG LLP, 122 EAST 42ND STREET, SUITE 4000, NEW YORK, NY, 10168, US

(73) Assignee: TAGAWASANGYO CO., LTD, TAGAWA-SHI FUKUOKA 826-0041 (JP)

(21) Appl. No.: 10/523,354

(22) PCT Filed: Jan. 30, 2003
(86) PCT No.: PCT/JP03/00941

§ 371 Date: Jan. 28, 2005

(30) Foreign Application Priority Data
Jul. 29, 2002 (JP) 2002-220050

(51) Int. Cl. B27N 3/00

(52) U.S. Cl. 264/71; 264/109

(57) ABSTRACT

A method of patterning the surface of a molded article obtained by pressure-molding a powdery inorganic binder material which comprises vibrating the powdery inorganic binder material to thereby smoothen the surface thereof, then disposing a colored material having a different color from the inorganic binder material on the surface of the inorganic binder material and then pressure-molding the inorganic binder material together with the colored material to thereby form a pattern on the surface of the molded article. Thus, a pattern can be conveniently and economically formed on the surface of a molded article.

### TECHNICAL FIELD

The present invention relates to a method of forming a pattern on the surface of a molded article and, more particularly, to a method of forming a pattern on the surface of a molded article obtained by pressure-molding a powdery inorganic binder material.

### BACKGROUND TECHNOLOGY

Heretofore, a pattern has been formed on the surface of a molded article by customary methods which comprise processes of drawing a pattern with a glaze material directly on the surface of the molded article and then calcining the molded article or processes of transcribing a pattern from a patterned paper on the surface of the molded article and then calcining the molded article.

These conventional methods of forming the pattern on the surface of the molded article, however, require the calcining process so that a long period of time and a large amount of laborious work are needed to form the pattern on the surface of the molded article.

Moreover, on the one hand, the process for drawing a pattern directly on the surface of a molded article has the disadvantage that the pattern cannot be corrected with ease.

On the other hand, the process for transcribing a pattern from a patterned paper onto the surface of a molded article also has the disadvantage that it requires the use of a special apparatus and laborious work for transcription.

Therefore, the present invention has the object to provide a method of forming a pattern on the surface of a molded article without requiring any calcining process and any laborious work.

### DISCLOSURE OF THE INVENTION

The present invention according to the first aspect provides a method for forming a pattern on the surface of a molded article obtained by pressure-molding a powdery inorganic binder material, which comprises a series of processes composed of flattening the surface of the powdery inorganic binder material by providing vibration to the powdery inorganic binder material, disposing a colored material colored by a color different from a color of the inorganic binder material on the surface of the inorganic binder material and then pressure-molding the inorganic binder material together with the colored material to thereby form a pattern on the surface of the molded article.

The present invention according to the second aspect provides a method of forming a pattern on the surface of a molded article obtained by pressure-molding a powdery inorganic binder material, which comprises a series of processes composed of disposing the powdery inorganic binder material into a bottom mold of a pressure-molding apparatus, flattening the surface of the inorganic binder material by applying vibration to the inorganic binder material with a vibrator, then disposing a colored material colored by a color different from a color of the inorganic binder material on the surface of the inorganic binder material and then pressure-molding the inorganic binder material together with the colored material to thereby form a pattern on the surface of the molded article.

The present invention according to the third aspect provides the method as described above in the first or second aspect, which further comprises disposing a base substrate with the colored material coated thereon on the flattened surface of the inorganic binder material in a state in which the surface of the base substrate is in abutment with the surface of the inorganic binder material and then pressure-molding the inorganic binder material and the colored material together with the base substrate.

The present invention according to the fourth aspect provides the method as described above in the third aspect, which further comprises a series of processes composed of drawing a design on the back surface of a transparent base substrate in advance, the design being substantially identical to a pattern to be formed on the surface of the inorganic binder material, and then coating the surface of the base substrate with a colored material along the design.

The present invention according to the fifth aspect provides a method of forming a pattern on the surface of the molded article obtained by pressure-molding a powdery inorganic binder material, which comprises a series of processes composed of disposing a colored material colored by a color different from a color of the inorganic binder material on the back surface of a base substrate, disposing a powdery inorganic binder material on the back surface of the base substrate and further pressure-molding the powdery inorganic binder material together with the base substrate, followed by separating the molded article from the base substrate to thereby form a pattern on the surface of the molded article.

The present invention according to the sixth aspect provides the method as described above in the fifth aspect, which further comprises a series of processes composed of drawing in advance a design on the back surface of a transparent base substrate, the design being substantially identical to a pattern to be formed on the surface of the inorganic binder material, and then disposing the colored material on the surface of the base substrate along the design.

The present invention according to the seventh aspect provides the method as described above in any one of the first to sixth aspects, wherein the colored material comprises an aqueous solution of the inorganic binder material to which a pigment is added.

The present invention according to the eighth aspect provides the method as described above in the seventh aspect, wherein adhesive is added to the colored material.

### BRIEF DESCRIPTION OF THE ACCOMPANYING DRAWINGS

FIG. 1 is a schematic illustration showing a method of forming a pattern in accordance with the first embodiment.

FIG. 2 is a side view in section showing a vessel.

FIG. 3 is an enlarged view showing the same portion as above.

FIG. 4 is a schematic illustration showing a state in which a colored material is disposed on the surface of an inorganic binder material.

FIG. 5 is a schematic illustration showing a molded article.

FIG. 6 is a schematic illustration showing a process for coating a base substrate with a colored material.

FIG. 7 is another schematic illustration showing a process for coating a base substrate with a colored material.

FIG. 8 is a schematic illustration showing a method of forming a pattern in accordance with the second embodiment.

FIG. 9 is a schematic illustration showing a method of forming a pattern in accordance with the third embodiment.

FIG. 10 is a perspective view showing a molded article.

FIG. 11 is a partially cut-away view in section showing the same portion as above.

FIG. 12 is a schematic illustration showing a process for disposing a colored material on a base substrate.

FIG. 13 is a schematic illustration showing a method of forming a pattern in accordance with the fourth embodiment.

### BEST MODES FOR CARRYING OUT THE INVENTION

The method of forming a pattern on the surface of a molded article according to the present invention is composed of the following processes.

The first process comprises charging a powdery inorganic binder material into the inside of a vessel.

As used herein, the term “vessel” is intended to refer to any vessel prepared separately for transportation or a mold for use with a pressure-molding apparatus.

The powdery inorganic binder material charged into the vessel is then subjected to application of vibration to the vessel. The vibration can flatten the surface of the inorganic binder material in the vessel and further increase the density of the inorganic binder material in a uniform way. By applying vibration to the inorganic binder material, the surface of the inorganic binder material can be flattened, and a colored material is then disposed on the flattened surface of the inorganic binder material. Moreover, the application of vibration to the inorganic binder material can increase the uniform density of the inorganic binder material, and the increase in the uniform density of the inorganic binder material can uniform the distribution of the density of the inorganic binder material, thereby permitting the distribution of the density inside a molded article prepared by pressure-molding processes to be uniformed and as a result increasing the intensity of the molded article.

Then, a colored material colored by a color different from a color of the inorganic binder material is disposed on the surface of the inorganic binder material. This allows a pattern to be formed with the colored material on the surface of the inorganic binder material. Moreover, a pattern can be formed by disposing the colored material from the surface side of the inorganic binder material which constitutes a surface (an exposed face) of the molded article after pressure-molding, so that the work for forming a pattern can be conducted while a finished state (an exposed state on the surface of the molded article) of the pattern can be anticipated; the work for forming the pattern can be carried out with ease.

As processes for disposing the colored material on the surface of the inorganic binder material, there may be mentioned, for example, a process comprising disposing a powdery colored material directly on the surface of the inorganic binder material and a process comprising coating the surface of a base substrate with a colored material having a viscosity and then disposing a base substrate on the flattened inorganic binder material in such a state that the surface of the base substrate (a coated surface of the colored material) is in abutment with the surface (an upper surface) of the inorganic binder material. In this case, pressure is applied to the inorganic binder material and the colored material together with the base substrate.

Finally, the molded article is formed by pressure-molding the inorganic binder material and the colored material and at the same time a pattern is formed on the surface of the molded article.

The above processes allow the colored material to be exposed onto the surface of the molded article to thereby form a pattern on the surface of the molded article.

Another method of forming a pattern on the surface of the molded article may comprise the following processes.

First, a colored material colored by a color different from the color of the inorganic binder material is disposed on the back surface of a base substrate (a plastic sheet).

Upon disposing the colored material on the base substrate, the colored material may be disposed directly on the back surface of the base substrate or coated on the back surface of the base substrate with a brush. The colored material may be filled in a tube and coated onto the back surface of the base substrate by using such a tube.

In disposing the colored material on the base substrate, a design may be drawn in advance on the surface of a transparent base substrate, the design being substantially identical to a pattern to be formed on the surface of the molded article, and the colored material may then be disposed on the back surface of the base substrate along the design.

Then, a mold composed of a pair of top and bottom molds may be used, and the base substrate may be disposed inside the bottom mold in such a state that the bottom surface is directed upwards.

The inside of the bottom mold is then filled with the powdery inorganic binder material by disposing the powdery inorganic binder material on the back surface (the top) of the base substrate.

Further, the powdery inorganic binder material filled inside the bottom mold and the base substrate are molded by applying high pressure thereto by means of the top bottom.

Finally, the molded article is removed from the bottom mold by separating it from the base substrate.

The above process permits the colored material to expose onto the surface of the molded article to thereby form a pattern on the surface of the molded article.

The colored material to be used for the present invention may include, for example, various kinds of stone materials, glass or metallic materials or a colored material prepared by adding a pigment to an aqueous solution of the inorganic binder material.

As the inorganic binder material to be used as a raw material for the colored material, there may be used, for example, a material capable of forming a cured material upon ready reaction with carbonic acid gas or water in air, such as slaked lime, dolomite, gypsum, magnesium hydroxide or the like. It is further to be noted herein that the inorganic binder material as the raw material for the colored material, including slaked lime, dolomite, gypsum, magnesium hydroxide or the like, may be used singly or in the form of a mixture of two or more.

As the pigment, there may be used, for example, an iron oxide calcined at a different calcining temperature in the case of using a colored material having a red color, a yellow color, a brown color or a black color; a chromium oxide in the case of using a colored material having a green color; a cobalt oxide in the case of using a colored material having a blue color. Moreover, colored materials having various colors may be prepared by admixture of these colored materials at different rates.

It is also possible to increase the viscosity of the colored material by addition of adhesive in the amount of from approximately 0% by weight to approximately 10% by weight. Such adhesive may include, for example, a chemically synthesized adhesive such as a methylcellulose-derived one which has been widely used as a food additive, or adhesive obtainable from a sea weed.

As the powdery inorganic binder material to be used for the present invention, there may be used, for example, a material including, but being not limited to, slaked lime, dolomite, gypsum or magnesium hydroxide, the material being, e.g., a material capable of being cured readily upon reaction with carbonic acid gas or water present in air. It is to be noted herein that slaked lime, dolomite, gypsum, magnesium hydroxide, etc. as the powdery inorganic binder material may be used singly or in the form of a mixture of two or more kinds as illustrated above.

An inorganic filler may also be added to the inorganic binder material or the colored material. Such an inorganic filler may include, for example, calcium carbonate, quartz sand, slug, fly ash, incinerated ash, sludge, iron oxide powders and so on. In addition, there may be included, for example, an inorganic porous material such as silica gel, zeolite, activated carbon, diatomaceous earth, etc., a clay such as kaolin, bentonite, sepiolite, etc., an inorganic pigment such as iron oxide, etc., a functional inorganic catalyst such as titanium oxide, zinc oxide, etc., an anti-fungus/anti-fumigant agent, inorganic fibers such as chrysotile, wollastonite, glass fibers, etc., natural fibers such as pulp, linen fibers, etc., synthetic fibers such as vinylon fibers, polyethylene fibers, etc., a fluorescent stone, a light storage stone, an adsorbent agent, a repellent agent, and so on. The addition of the inorganic filler can increase an added value of the resulting molded article.

The components may be mixed in such a manner that the inorganic binder material or the colored material is at the rate of from 20% to 100% by weight and the inorganic filler is at the rate of from 0% to 80% by weight. The inorganic porous material, clay, inorganic pigment, functional inorganic catalyst, anti-fungus, anti-fumigant agent, inorganic fibers and so on may be admixed at the rate of 0.1% to 50% by weight.

A powder mixture of the inorganic binder material, the colored material, the inorganic filler, and so on may be moistened or dried to adjust a degree of moisture to 0% to 10%.

The molding pressure to be applied to the powder mixture upon pressure-molding may be 100 MPa or higher, preferably in the range of from 100 MPa to 300 MPa.

By molding the powder mixture at high pressure under substantially vacuum conditions in the manner as described above, the resulting molded article can be formed with substantially no air left inside, thereby providing the resulting molded article with a high physical strength and a high dimensional accuracy.

In cases where the molded article is stayed in air or cured under atmosphere of carbonic acid gas after pressure-molding, slaked lime or the like used as the inorganic binder material may be reacted to calcium carbonate by absorbing carbonic acid gas by the following reaction scheme:
Ca(OH)₂+CO₂→CaCO₃+H₂O
This can further increase the physical strength of the resulting molded article.

In particular, in cases where the viscosity of the colored material is increased by the addition of adhesive to the colored material, the inorganic binder material can easily be coated on the surface thereof with the colored material to a greater thickness, this can further increase the thickness of a pattern and make it more difficult or unlikely to cause the pattern falling from the surface of the resulting molded article.

Moreover, the pattern-forming method according to the present invention utilizes no heat treatment such as calcining, autoclave treatment, etc., unlike methods for preparing bricks, tiles or the like, so that the inorganic porous material, clay, functional inorganic catalyst, anti-fungus/anti-fumigant agent and the like do not undergo a thermal influence even if they would be added. Therefore, the molded article can be formed while each of the raw materials such as the inorganic porous material, clay and so on can hold its own properties. Moreover, the resulting molded article can increase added values for the resulting molded article.

In addition, as the method of the present invention is subjected to no heat treatment, no colors are caused to change due to changes of temperature in a kiln, so that the molded articles can be prepared in a large quantity, which have substantially the same colors as those of the powder mixture before pressure-molding.

Furthermore, unlike cement products, the raw materials are not used in a slurry state so that colors can be produced to a sufficient extent by adding the pigment in an amount as small as 5% by weight or less without causing any blushing.

The addition of fibers to the inorganic binder material or the colored material can increase the bending strength of the resulting molded article.

The addition of wollastonite that is one of the inorganic fibers can further produce high impact resistance and breaking strength inherent in the wollastonite, thereby increasing the compression strength of the resulting molded article.

As the method according to the present invention can form a pattern on the surface of the resulting molded article with ease without utilizing any calcining process, a duration of time and labor required for forming a pattern on the surface of the molded article can be reduced so that no special device is needed separately and as a result an increase of costs in accompany with the formation of the pattern can be prevented.

Further, as the method of the present invention applies pressure to the inorganic binder material together with the base substrate, the base substrate is located between the colored material and the mold at the time of pressure-molding so that damages can be prevented to occur in advance on the surface of the molded article even if a hard material would be used as the colored material.

In particular, in cases where the inorganic binder material to be used as a raw material for the colored material forming a pattern is used which has properties substantially identical to the properties of the molded article, the colored material forming a pattern can be joined to the inorganic binder material in a more secured manner because the colored material has the similar properties to those of the inorganic binder material. This can prevent the pattern from falling down from the surface of the resulting molded article.

Further, the colored material forming the pattern is located inside the molded article by the depth as thick as the colored material coated on the base substrate so that the pattern can be prevented from falling down from the surface of the molded article even if the pattern would be worn out.

Therefore, the method according to the present invention can assist in elongating a life of the pattern on the surface of the resulting molded article.

In particular, in cases where the viscosity of the colored material is increased by the addition of the adhesive to the colored material, the colored material allows a thick coating to be coated with ease on the surface of the base substrate so that a thicker pattern can be formed and thus the pattern can be prevented to a higher extent from falling down from the surface of the molded article.

Moreover, in cases where a transparent base substrate is used as the base substrate and a design substantially similar to a pattern to be formed on the surface of the molded article is drawn on the surface of the transparent base substrate and then the colored material is coated on the back surface of the base substrate along the design drawn on the transparent base substrate, the pattern can be drawn along the design easily by anyone without requiring any experienced skill for drawing the pattern and the work for forming a pattern on the surface of the molded article can be carried out in an easy way.

The following description is an explanation of specific embodiments of examples of the present invention with reference to the accompanying drawings.

### FIRST EMBODIMENT

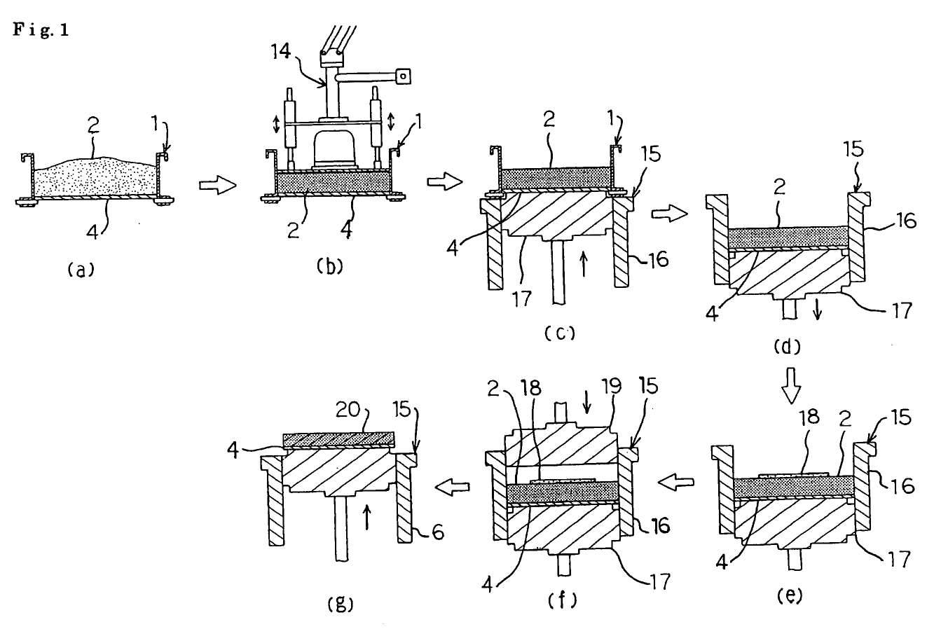

First, as shown in FIG. 1(a), a vessel 1 for transportation is charged with a powdery inorganic binder material 2.

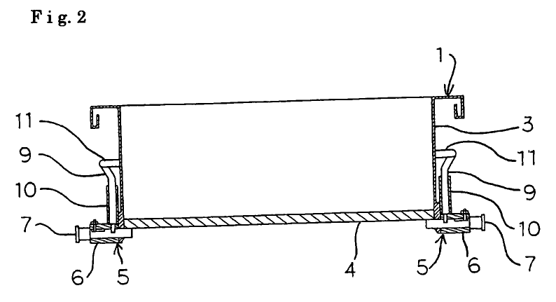

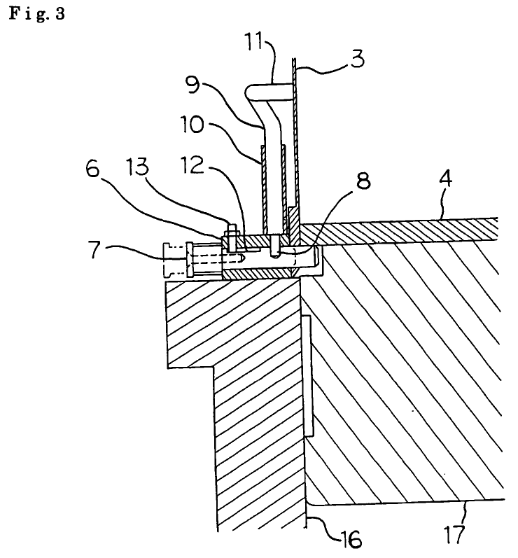

As shown in FIGS. 2 and 3, the vessel 1 for transportation is detachably provided with a bottom plate 4 having a rectangular plate form on the bottom portion of a vessel body 3 in the form of a rectangular frame to form a rectangular box with the top open.

Between the vessel body 3 and the bottom plate 4 are four of bottom plate support mechanisms 5, when looked in a plane view, and the bottom plate 4 is supported from the bottom side by the bottom plate support mechanisms 5 to thereby prevent the bottom plate 4 from falling down from the vessel body 3.

The bottom plate support mechanism 5 is provided with a hollow cylindrical boss 6 on a lower portion of the outer peripheral face of the vessel body 3, and a support pin 7 is inserted through a hollow portion of the boss 6 to thereby support the bottom plate 4 by the tip of the support pin 7.

The bottom plate support mechanism 5 is disposed to fix the support pin 7 to the boss 6 by providing the support pin 7 with a lock hole 8 at an upper part of the intermediate portion of the support pin 7 as well as mounting the lock pin 8 on the tip portion of the lock pin 9 in a vertically movable way, and engaging the tip portion of the lock pin 9 into the lock hole 8. In the drawings, reference numeral 10 refers to a hollow cylinder-shaped pin support body inserted into the lock pin 9, and reference numeral 11 refers to a handle formed by bending the top portion of the lock pin 9.

The bottom plate support mechanism 5 is further disposed to regulate the movable range of the support pin 7 and prevent the support pin 7 from falling down from the boss 6 by providing an engagement groove 12 at an upper part of the intermediate portion of the support pin 7 as well as mounting an engagement pin 13 at the upper portion of the boss 6 and engaging the engagement pin 13 in the engagement groove 12.

Then, as shown in FIG. 1(b), vibration is applied to the inorganic binder material 2 with a vibrator 14 disposed over the vessel 1 to flatten the surface of the molded article 2. The application of vibration can increase a density of the molded article 2.

Thereafter, as shown in FIG. 1(c) and (d), the bottom plate 4 of the vessel 1 and the inorganic binder material 2 are disposed on top of a bottom mold 17 of a pressure-molding apparatus 15.

The pressure-molding apparatus 15 to be used herein has a structure in which the bottom mold 17 is disposed inside a peripheral wall 16 in the form of a rectangular frame in a vertically movable manner.

As specifically shown in FIG. 1(c), the vessel 1 is disposed on top of the peripheral wall 16 of the pressure-molding apparatus 15 and the bottom mold 17 of the pressure-molding apparatus 15 is transferred to the top of the peripheral wall 16 thereof so as to abut the top face of the bottom mold 17 with the lower face of the bottom plate 4. Thereafter, as shown in FIG. 1(d), the support pin 7 of the bottom plate support mechanism 5 is transferred backward in order to separate the bottom plate 4 from the vessel body 3, and the bottom mold 17 of the pressure-molding apparatus 15 is transferred downwards in this state. This permits the bottom plate 4 of the vessel 1 and the inorganic binder material 2 disposed on top of the bottom plate 4 to be disposed easily in this state on top of the bottom mold 17 of the pressure-molding apparatus 15.

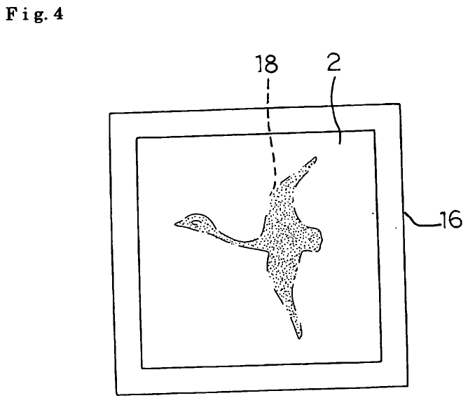

Then, as shown in FIG. 1(e), a colored material 18 in a powdery form is the in a predetermined shape (a pattern) on the surface (a top surface) of the inorganic binder material 2, the colored material 18 being in turn colored by a color different from a color of the inorganic binder material (also refer to FIG. 4). In this embodiment, the inorganic binder material 2 is disposed on the surface of the inorganic binder material 2 after the inorganic binder material 1 has been disposed on top of the bottom mold 17. It is to be noted herein, however, that the inorganic binder material 2 and the colored material 2 may be disposed on top of the bottom mold 17 after the colored material 18 has been disposed on the surface of the inorganic binder material 2 in the inside of the vessel 1.

The colored material 18 to be used herein may be prepared by dissolving a powdery inorganic binder material in water to yield an aqueous solution (a whitewash) of the inorganic binder material in a paste form and adding a powdery pigment in an amount of approximately 0% to 30% by weight in accordance with a predetermined color as well as then stirring and mixing the resulting mixture with a mixer for approximately 5 minutes, followed by drying and pulverizing the resulting mixture in a powdery form.

Thereafter, as shown in FIG. 1(f), a molded article 20 can be formed by pressure-molding the powdery inorganic binder material 2 and the colored material 3 together with the bottom plate 4 with a top mold 19 and the bottom mold 17 of the pressure-molding apparatus 15 at high pressure by transferring the top mold 19 downwards. In this embodiment, a vacuum molding apparatus can be used as the pressure-molding apparatus 15, and the resulting powder mixture can be pressure-molded in a plate or bulk form in an approximately vacuum state in which a pressure-molding space to be formed between the top mold 19 and the bottom mold 17 is maintained at pressure as low as −80 KPa to −100 KPa by means of the action of a vacuum pump (not shown) communicating operatively with the bottom mold 17.

Finally, as shown in FIG. 1(g), the bottom mold 17 is raised again to separate and remove the resulting molded article 20 by separating it from the bottom plate 4.

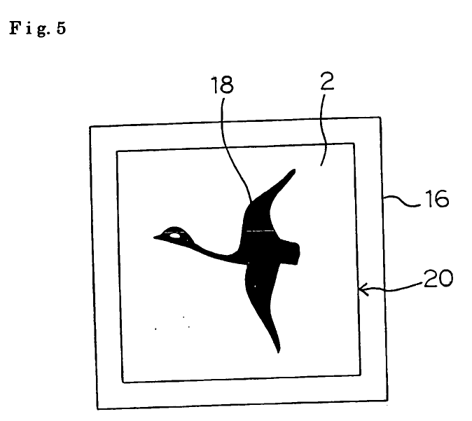

The following process allows the colored material 18 to appear on the surface of the molded article 20 (as shown in FIG. 5) and the appearance of the colored material 18 can form a pattern on the surface of the molded article 20.

As described in this embodiment, the pattern can be readily formed on the surface of the molded article 20 without using the calcining process and a duration of time and labor required otherwise for forming such a pattern thereon can be reduced. Further, an increase of costs required for forming a pattern on the surface of the molded article can be prevented because no special device for forming such a pattern is needed separately.

In addition, by using a raw material as the colored material 18 forming a pattern, which is a material substantially equal in properties to the inorganic binder material 2, the inorganic binder material 2 can be joined to the inorganic binder material 2 in a secured manner because the colored material 18 has substantially equal properties to the inorganic binder material 2. This can join the pattern to the surface of the molded article 20 in a secured way to thereby prevent the pattern from falling down from the surface of the molded article 20.

Furthermore, as the colored material 18 forming a pattern is located in the inside of the molded article 20 by a thickness of a coating of the colored material 18, the pattern does not fall down from the surface of the molded article 20 even if the surface of the molded article 20 would be worn away.

Therefore, the present invention can assist in making a long life of the pattern formed on the surface of the molded article 20.

### SECOND EMBODIMENT

First, a colored material 21 in a paste form is formed by dissolving a powdery inorganic binder material in water to yield an aqueous solution in a paste form, adding a powdery pigment at the rate of approximately 0% to 30% by weight in accordance with a given color as well as stirring and mixing the resulting powder mixture for about 5 minutes with a mixer.

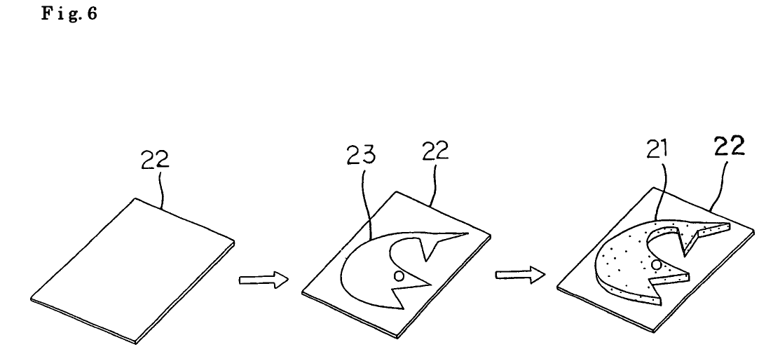

Next, a pattern to be formed with the colored material 21 on the surface of the molded article is drawn on the back surface of a base substrate 22 (a plastic sheet) by coating the colored material 21 on the back surface of the base substrate 22 with a brush (as shown in FIG. 6(c)). The colored material 21 may be used by filling it in a tube and then coating on the back surface of the base substrate 22 with the tube.

In this process, a design 23 may be drawn on the back surface of the base substrate 22 in such a manner that the design corresponds to a pattern turned outside in (as shown in FIGS. 6(a) and (b)). This allows the colored material 21 to be coated along the design 23, thereby carrying out the work for coating the colored material 21 in an easier way.

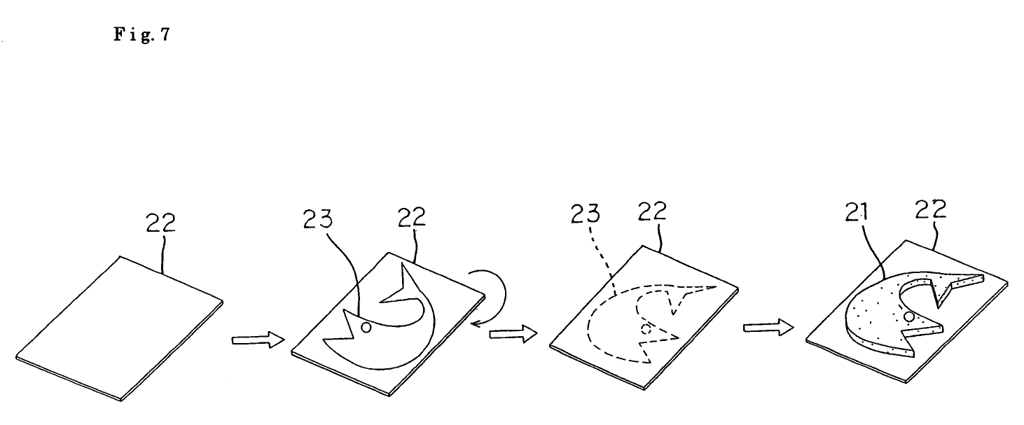

Further, by using a transparent base substrate as the base substrate 22, the design 23 having a shape substantially identical to the pattern to be formed on the surface of the molded article has been previously drawn on the surface of the transparent base substrate 22, and the base substrate 22 is then turned outside in, followed by coating the back surface of the base substrate 22 along the design 23 (as shown in FIG. 7(a) to (d), inclusive).

In addition, the colored material 21 can be coated on the back surface of the base substrate 22 in a superimposed manner in order to thicken a coat of the pattern formed by the colored material after the pressure-molding process.

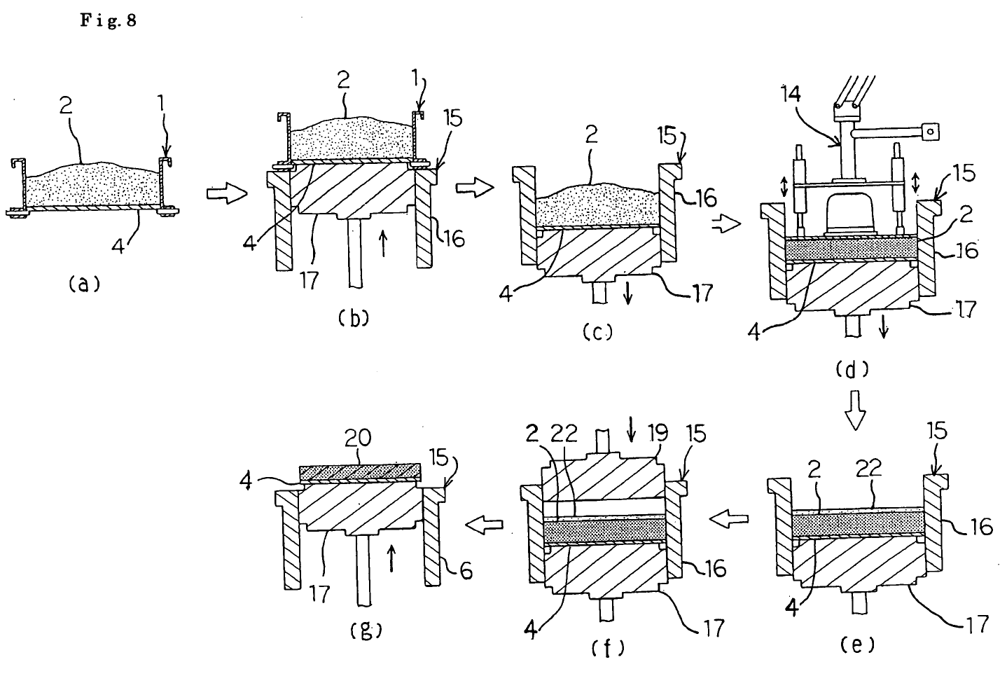

Then, as shown in FIG. 8(a), a powdery inorganic binder material 2 is charged into the vessel 1 for use in transportation.

Next, as shown in FIGS. 8(b) and 8(c), the bottom plate 4 and the inorganic binder material 2 are disposed on top of the bottom mold 17 of the pressure-molding apparatus 15.

Then, as shown in FIG. 8(d), vibration is applied to the inorganic binder material 2 with a vibrator 14 disposed over the vessel 1 to flatten the surface of the molded article 2. The application of vibration can increase a density of the inorganic binder material 2.

Thereafter, as shown in FIG. 8(e), a base substrate 22 with a colored material 21 colored by a color different from the color of the inorganic binder material 2 coated on the surface thereof (as shown in FIG. 6 or FIG. 7) is disposed on the surface (a top surface) of the inorganic binder material 2. In this case, the surface (a surface to be coated) of the base substrate 22 is disposed on the surface (a top surface) of the inorganic binder material 2.

As shown in FIG. 8(f), a molded article 20 can then be formed by pressure-molding the powdery inorganic binder material 2 and the base substrate 22 together with the bottom plate 4 by means of a top mold 19 and a bottom mold 17 of the pressure-molding apparatus 15 at high pressure by transferring the top mold 19 of the pressure-molding apparatus 15 downwards. This can form the molded article 20 by joining to the inorganic binder material 2 while the colored material 21 coated on the surface of the base substrate 22 is being peeled off from the base substrate 22.

Finally, as shown in FIG. 8(g), the bottom mold 17 is raised again to remove the resulting molded article 20 by separating it from the bottom plate 4 and then removing the base substrate 22 from the surface of the resulting molded article 20.

The following processes allow the colored material 18 to appear on the surface of the molded article 20 and the appearance of the colored material 18 can form a pattern on the surface of the molded article (as shown in FIG. 5).

As described in this embodiment, as the inorganic binder material 2 and the colored material 21 are pressed through the base substrate 22 with the top mold 19, the inorganic binder material 2 and the colored material 21 are not in direct contact with the surface (a bottom surface) of the top mold 19, so that it is possible to prevent the inorganic binder material 2 and the colored material 21 from attaching to the surface (the bottom surface) of the top mold 19. Therefore, the molded articles 20 can be formed with a good finish surface even if the pressure-molding process can be carried out without attachment of the previously used inorganic binder material 2 or colored material 21 to the surface of a resulting molded article 20 immediately after the previous preparation of the molded article 20 even if the same top mold 19 as previously used would be used in a repeated way.

### THIRD EMBODIMENT

First, a colored material 31 in a paste form is formed by dissolving a powdery inorganic binder material in water to yield an aqueous solution (a whitewash) in a paste form, adding a powdery pigment at the rate of approximately 0% to 30% by weight in accordance with a given color as well as stirring and mixing the resulting powder mixture for about 5 minutes with a mixer.

Next, a pattern to be formed with the colored material 31 on the surface of the molded article is drawn on the back surface of a base substrate 32 (a plastic sheet) by coating the colored material 21 on the back surface of the base substrate 32 with a brush (as shown in FIG. 6(c) of the first embodiment). The colored material 31 may be used by filling it in a tube and then coating it on the back surface of the base substrate 32 with the tube.

In this instance, a design 33 may be drawn on the back surface of the base substrate 32 by drawing a pattern with the top face thereof turned in on the back surface of the base substrate 32 (as shown in FIGS. 6(a) and (b) of the first embodiment). This allows the colored material 21 to be coated along the design 33, thereby carrying out the work for coating the colored material 31 in an easier way.

Further, by using a transparent base substrate as the base substrate 32, the design 33 having a shape substantially identical to the pattern to be formed on the surface of the molded article has been previously drawn on the back surface of the transparent base substrate 32, and the base substrate 32 is then turned upside down, followed by coating the back surface of the base substrate 32 along the design 33 (refer to FIG. 7(a) to (d), inclusive, for the first embodiment).

In addition, the colored material 31 can be coated plural times on the back surface of the base substrate 32 in a superimposed manner in order to thicken a coating of the pattern formed by the colored material after the pressure-molding process.

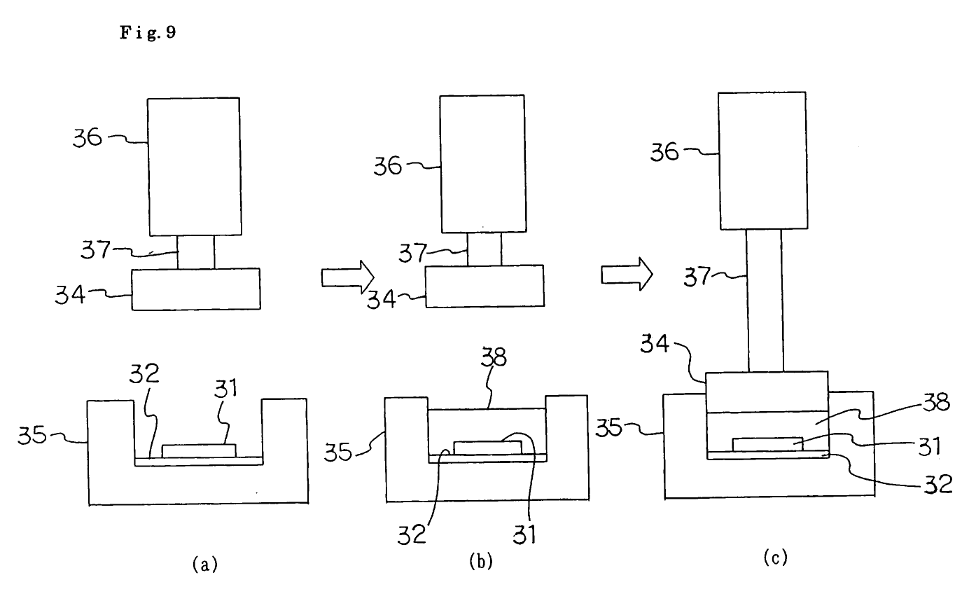

Next, as shown in FIG. 9(a), the base substrate 32 is disposed with the back surface thereof directed upwards in the inner side portion of a bottom mold 35 out of a pair of a top mold 34 and the bottom mold 35. In FIG. 9, reference numeral 36 refers to a cylinder for raising or lowering the top mold 34, which operatively couples the top mold 34 with a bottom tip portion of a rod 37 of the cylinder 36.

Next, a powdery inorganic binder material 38 is filled inside the bottom mold 35 by disposing the powdery inorganic binder material 38 on the back surface (on top) of the base substrate 32 (as shown in FIG. 9(b)).

Then, a molded article 39 can be formed by pressure-molding the powdery inorganic binder material 38 filled in the inner side portion of the bottom mold 35 together with the base substrate 32 at high pressure by means of the top mold 34 (see FIG. 9(c)). It is to be noted herein that the pressure-molding process may pressure-mold a powder mixture into a plate form or in a bulk form by using a vacuum pressure-molding apparatus and utilizing the action of a vacuum pump (not shown) operatively coupled with the bottom mold 35 in an approximately vacuum state generated by adjusting a pressure-molding space formed between the top mold 34 and the bottom mold 35 to pressure as low as −80 KPa to −100 KPa.

Finally, the resulting molded article 39 is removed from the bottom mold 35 and separated from the base substrate 32.

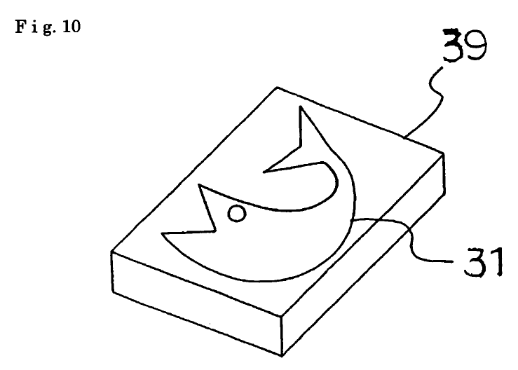

The following process allows the colored material 31 coated on the base substrate 32 to appear on the molded article 39 (as shown in FIG. 10) and the appearance of the colored material 18 can form a pattern on the surface of the molded article 39.

As described in this embodiment, the pattern can be formed with ease on the surface of the molded article 39 without using the calcining process, and this can reduce a duration of time and labor required for forming the pattern. Further, as no special device for forming the pattern is required separately, an increase in costs for forming the pattern can be prevented.

Moreover, the inorganic binder material 38 having properties substantially identical to those of a raw material of the molded article 39 is used as a raw material for the colored material 31 forming the pattern, so that the pattern can be joined to the molded article 39 in a secured manner because the inorganic binder material 31 forming the pattern is substantially identical in properties to the molded article 39. The secured joining of the pattern to the molded article 39 can prevent the pattern from being peeled out from the surface of the molded article 39 and falling down therefrom.

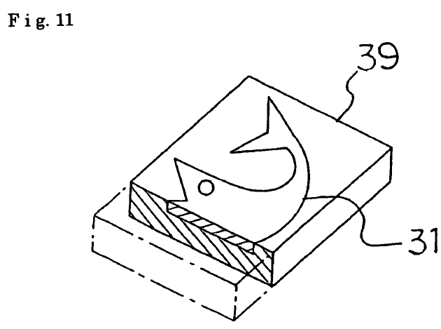

In addition, as the colored material 31 constituting the pattern is located inside the molded article by a depth corresponding to the thickness of the colored material 31 coated on the base substrate 32 (as shown in FIG. 11), the pattern is not peeled off from the surface of the molded article 39 and does not fall down therefrom even if the surface of the molded article 39 would be worn out.

Furthermore, by using a transparent base substrate as the base substrate 32 as well as drawing a design 33 on the surface of the transparent base substrate 32, the design 33 being previously drawn substantially identically to the pattern to be formed on the surface of the molded article 39 and then coating the inorganic binder material 31 on the back surface of the base substrate 32 along the design 33, the pattern can be formed with ease by anyone on the basis of the design without requiring any experienced skills for drawing the pattern. Moreover, the work for forming the pattern can be carried out with ease because the design 33 drawn on the base substrate 32 can be corrected or modified easily.

### FOURTH EMBODIMENT

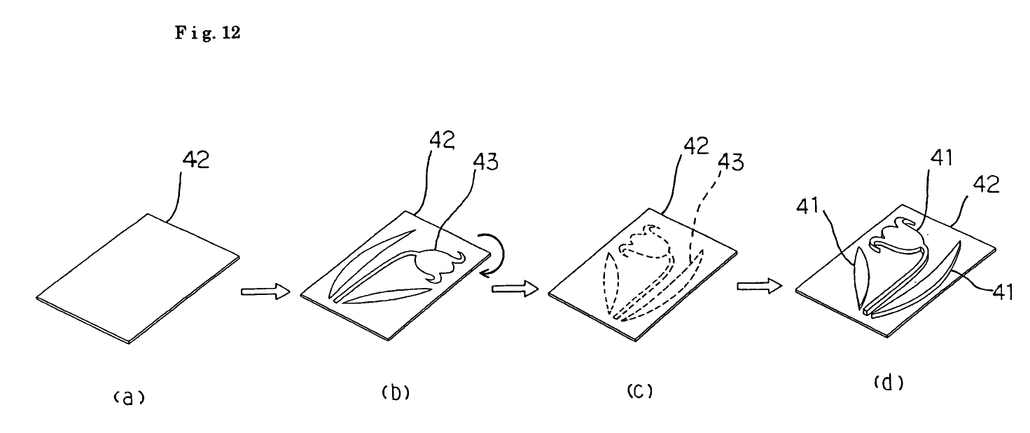

First, a transparent base substrate 42 was used as a base substrate 42 (as shown in FIG. 12(a)), and a design 43 having a shape substantially identical to a pattern to be formed on the surface of the molded article was drawn in advance on the surface of the transparent base substrate 42 (as shown in FIG. 12(b)). Thereafter, the front surface of the base substrate 42 was turned in (as shown in FIG. 12(d)) and then the pattern to be formed on the surface of the resulting molded article is drawn on the back surface of the base substrate by disposing the colored material 41 on the back surface of the base substrate 42 (a plastic sheet) along the design 43 (as shown in FIG. 12(c)). This allows the colored material 41 to be disposed along the design 43, thereby conducting the work for disposing the colored material 41 with ease.

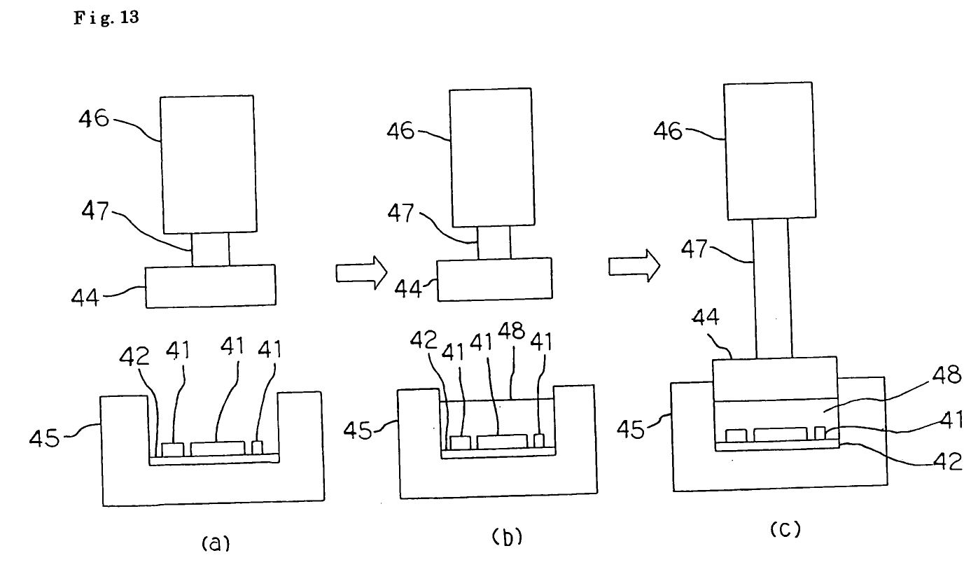

Next, the base substrate 42 is disposed with the back surface thereof directed upward inside the bottom mold 45 out of a pair of the top mold 44 and the bottom mold 45 (as shown in FIG. 13(a)) in the manner as described above in the third embodiment. In FIG. 13, reference numeral 46 refers to a cylinder for transferring the top mold 44 upwards and downwards, which operatively couples the top mold 44 with the bottom end portion of a rod 47 of the cylinder 46.

Further, a powdery inorganic binder material 48 was filled into the inside of the bottom mold 45 by disposing the powdery inorganic binder material 48 on the back surface (a top face) of the base substrate 42 (as shown in FIG. 13(b)).

Next, the molded article 49 was prepared by pressure-molding the inorganic binder material 48 filled in disposed inside of the top mold 45 together with the base substrate 42 at high pressure in association with the top mold 44 (as shown in FIG. 13(c)). It is to be noted herein that the pressure-molding process may pressure-mold a powder mixture into a plate form or a bulk form by using a vacuum pressure-molding apparatus and utilizing the action of a vacuum pump (not shown) operatively coupled with the bottom mold 45 in an approximately vacuum state generated by adjusting a pressure-molding space formed between the top mold 44 and the bottom mold 45 to pressure as low as −80 KPa to −100 KPa. The molding pressure to be applied to the powder mixture at the time of pressure-molding may be 100 MPa or higher, preferably in a range from 100 MPa to 300 MPa.

By molding at high pressure under approximately vacuum conditions, the molded article 49 can be formed with a high physical strength and a high dimensional accuracy because air is little left in the inside of the molded article 49.

Furthermore, as pressure was applied to the inorganic binder material 48 together with the base substrate 42, the base substrate 42 was located between the colored material 41 and the top mold 45, thereby suppressing the surface of the mold 45 in advance from causing damages even if a hard material were used as the colored material 41.

Finally, the resulting molded article 39 was removed from the bottom mold 35 and then separated from the base substrate 32.

The above process allows the colored material 41 disposed on the base substrate 42 to appear on the surface of the molded article 49 to thereby form a pattern on the surface of the molded article 49.

### INDUSTRIAL APPLICABILITY

The present invention can be carried out in a manner as described above and demonstrates the effects as will be described hereinafter.

More particularly, the present invention can form a pattern on the surface of the molded article by disposing the colored material from the surface side of the inorganic binder material constituting the surface (an exposure face) of the molded article after pressure-molding because the surface of the inorganic binder material can be flattened by applying vibration thereto and the colored material is then disposed on the surface of the inorganic binder material. Therefore, the work for forming the pattern can be carried out while anticipating a finish state of the pattern (an exposed state on the surface of the molded article) so that the work for forming the pattern can be carried out with ease.

Furthermore, as the application of vibration to the inorganic binder material can uniformly increase a density of the inorganic binder material to thereby uniform the distribution of the density of the inorganic binder material, the distribution of the density inside the molded article to be prepared by pressure-molding can be made so uniform that the strength of the molded article can be increased.

Moreover, in cases where the base substrate with the colored material coated thereon is disposed on the surface of the inorganic binder material and the inorganic binder material and the colored material are pressure-molded together with the base substrate, the method according to the present invention can prevent attachment of the inorganic binder material and the colored material to the top mold of a pressure-molding apparatus, thereby forming a good surface of the resulting molded article.

The method according to the present invention can form the pattern on the surface of the molded article with ease without calcining the inorganic binder material and can reduce a period of time and labor for forming the pattern. Further, as the method of the present invention does not require the use of a special device separately for forming the pattern, an increase in costs resulting from the formation of the pattern can then be prevented.

In addition, in cases where the inorganic binder material having properties identical to those of a raw material of the molded article is used as a raw material of the colored material forming the pattern, the pattern can be joined to the molded article in a secure way because the colored material forming the pattern is similar in properties to the inorganic binder material. This can prevent the pattern from being peeled from the surface of the molded article and falling down therefrom.

Furthermore, the colored material forming the pattern is located inside the molded article by a depth corresponding to a thickness of the colored material coated thereon so that the pattern is not peeled off and fallen down from the surface of the molded article.

Moreover, in cases where adhesive is added to the colored material, the viscosity of the colored material can be increased and the colored material can be coated on the back surface of the base substrate with ease to thereby increase a thickness of the pattern to a greater extent. Therefore, the pattern can be prevented from peeling off the pattern and falling down from the surface of the resulting molded article.

1. A method for forming a pattern on the surface of a molded article obtained by pressure-molding a powdery inorganic binder material, comprising:
flattening the surface of the powdery inorganic binder material by applying vibration to the powdery inorganic binder material, disposing a colored material consisting of the same material as the inorganic binder material and colored by a color different from a color of the powdery inorganic binder material on the surface of the inorganic binder material, and then pressure-molding the powdery inorganic binder material and the colored material to thereby form a pattern on the surface of the molded article.

2. A method for forming a pattern on the surface of a molded article obtained by pressure-molding a powdery inorganic binder material, comprising:
charging the powdery inorganic binder material in a bottom mold of a pressure-molding apparatus, flattening the surface of the powdery inorganic binder material by applying vibration to the powdery inorganic binder material, disposing a colored material consisting of the same material as the inorganic binder material and colored by a color different from a color of the powdery inorganic binder material on the surface of the inorganic binder material, and then pressure-molding the powdery inorganic binder material and the colored material to thereby form a pattern on the surface of the molded article.

3. The method for forming a pattern on the surface of a molded article as claimed in claim 1, wherein a base substrate with the colored material coated on the surface thereof is disposed on the flattened surface of the inorganic binder material in such a state that the surface of the base substrate is in abutment with the surface of the base substrate and then pressure is applied to the inorganic binder material and the inorganic binder material and the colored material together with the base substrate.

4. The method for forming a pattern on the surface of a molded article as claimed in claim 3, wherein a design is drawn in advance on the back surface of a transparent base substrate, the design being substantially identical in shape to the pattern to be formed on the surface of the molded article, and the colored material is coated on the surface of the base substrate along the design.

5. A method for forming a pattern on the surface of a molded article obtained by pressure-molding an inorganic binder material, comprising:
disposing a colored material colored by a color different from a color of the inorganic binder material on the back surface of a base substrate, then disposing a powdery inorganic binder material on the back surface of the base substrate, pressure-molding the powdery inorganic binder material together with the base substrate, and separating the molded article from the base substrate to thereby form a pattern on the surface of the molded article.

6. The method for forming a pattern on the surface of a molded article as claimed in claim 5, wherein a transparent base substrate is used as the base substrate, a design having a shape substantially identical to the pattern to be formed on the surface of the molded article is drawn on the back surface of the transparent base substrate, and the colored material is disposed along the design on the surface of the molded article.

7. The method for forming a pattern on the surface of a molded article as claimed in any one of claims 1 to 6 and 9, wherein the colored material is prepared by adding a pigment to an aqueous solution of the inorganic binder material.

8. The method for forming a pattern on the surface of a molded article as claimed in claim 7, wherein adhesive is added to the colored material.

9. The method for forming a pattern on the surface of a molded article as claimed in claim 2, wherein a base substrate with the colored material coated on the surface thereof is disposed on the flattened surface of the inorganic binder material in such a state that the surface of the base substrate is in abutment with the surface of the base substrate and then pressure is applied to the inorganic binder material and the inorganic binder material and the colored material together with the base substrate.
